(19) United States
(12) Patent Application Publication
(10) Pub. No.: US 2022/0385373 A1
(43) Pub. Date: Dec. 1, 2022

(54) WAVELENGTH CONVERTER, OPTICAL COMMUNICATION APPARATUS, AND OPTICAL WAVEGUIDE SUBSTRATE

(71) Applicant: FUJITSU LIMITED, Kawasaki-shi (JP)

(72) Inventors: Hidenobu MURANAKA, Kawasaki (JP); Tomoaki TAKEYAMA, Yokohama (JP); Takeshi HOSHIDA, Kawasaki (JP)

(73) Assignee: FUJITSU LIMITED, Kawasaki-shi (JP)

(21) Appl. No.: 17/686,177

(22) Filed: Mar. 3, 2022

(30) Foreign Application Priority Data
May 28, 2021 (JP) 2021-089769

(51) Int. Cl. H04B 10/61; G02B 6/14; G02F 1/365; H04B 10/516; H04B 10/2507

(52) U.S. Cl. CPC H04B 10/6163; G02B 6/14; G02F 1/365; H04B 10/5162; H04B 10/2507

(57) ABSTRACT

A wavelength converter includes an optical waveguide substrate configured to include a plurality of optical waveguides formed with different design values, an incidence-side optical fiber from which signal light and excitation light are incident to the optical waveguide substrate, and an emission-side optical fiber to which light including converted light having a wavelength different from a wavelength of the signal light is extracted from the optical waveguide substrate, wherein the incidence-side optical fiber and the emission-side optical fiber are optically coupled to one optical waveguide among the plurality of optical waveguides.

### CROSS-REFERENCE TO RELATED APPLICATION

This application is based upon and claims the benefit of priority of the prior Japanese Patent Application No. 2021-89769, filed on May 28, 2021, the entire contents of which are incorporated herein by reference.

### FIELD

The embodiments discussed herein are related to a wavelength converter, an optical communication apparatus, and an optical waveguide substrate.

### BACKGROUND

Along with an increase in amount of data communication, an increase in transmission capacity of an optical communication network is demanded. The transmission capacity may be increased by an increase in number of cores of an optical fiber cable, an increase in capacity for optical signal capacity per one wavelength, an increase in number of channels of wavelength-division multiplexing (WDM), and the like. As one of technologies for increasing the number of WDM channels, a wavelength conversion technology is developed. A transmission bandwidth is expanded by performing transmission in a new wavelength bandwidth in a transmission line while using an optical transceiver having a bandwidth developed in the related art. A nonlinear optical fiber is often used as a conversion medium for performing wavelength conversion, and due to manufacturing variations or the like, performance such as a zero-dispersion wavelength varies, and the transmission bandwidth is limited.

Meanwhile, research on wavelength conversion in a semiconductor optical waveguide of silicon or the like having high non-linearity is also progressed. The semiconductor optical waveguide is smaller than the nonlinear optical fiber. Since a manufacturing environment of silicon photonics has been significantly improved in recent years, improvement in accuracy of chromatic dispersion control including a transmission direction is expected by a material and structure design.

Japanese Laid-open Patent Publication No. 2005-321485, Japanese Laid-open Patent Publication No. 2015-31919, and U.S. Pat. No. 6,876,487 are disclosed as related art.

### SUMMARY

According to an aspect of the embodiments, a wavelength converter includes an optical waveguide substrate configured to include a plurality of optical waveguides formed with different design values, an incidence-side optical fiber from which signal light and excitation light are incident to the optical waveguide substrate, and an emission-side optical fiber to which light including converted light having a wavelength different from a wavelength of the signal light is extracted from the optical waveguide substrate, wherein the incidence-side optical fiber and the emission-side optical fiber are optically coupled to one optical waveguide among the plurality of optical waveguides.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram of an optical transmission system using a wavelength converter according to an embodiment;

FIG. 2 is a schematic diagram of the wavelength converter according to the embodiment;

FIG. 3 is a schematic diagram of an optical waveguide substrate;

FIG. 4 is a diagram illustrating a design example of the optical waveguide substrate according to a first embodiment;

FIG. 5A is a diagram illustrating dispersion with respect to an optical waveguide width at a specific excitation optical wavelength;

FIG. 5B is a diagram illustrating conversion efficiencies in various distributions;

FIG. 6 is a diagram illustrating an example of selecting an optical waveguide;

FIG. 7 is a schematic diagram of a wavelength converter incorporating an optical waveguide selection circuit;

FIG. 8 is a flowchart of selecting an optical waveguide according to the configuration illustrated in FIG. 7;

FIG. 9 is a schematic diagram of an optical waveguide substrate including an optical switch;

FIG. 10 is a flowchart of selecting an optical waveguide according to the configuration illustrated in FIG. 9;

FIG. 11 is a schematic diagram of an optical waveguide substrate according to a second embodiment;

FIG. 12 is a diagram illustrating waveguide height dependence of dispersion on an optical waveguide width;

FIGS. 13A and 13B are diagrams illustrating selection of an optical waveguide in accordance with a height variation of an optical waveguide;

FIG. 14 is a schematic diagram of an optical waveguide substrate according to a third embodiment;

FIG. 15 is a diagram illustrating selection of an optical waveguide in the optical waveguide substrate illustrated in FIG. 14;

FIG. 16 is a schematic diagram of an optical waveguide substrate according to a fourth embodiment;

FIG. 17 is a diagram illustrating an arrangement example of optical waveguides in the optical waveguide substrate illustrated in FIG. 16;

FIG. 18 is a diagram for describing selection of the optical waveguide in the optical waveguide substrate illustrated in FIG. 16;

FIG. 19 is a schematic diagram of a wavelength converter 30B according to a fifth embodiment; and

FIG. 20 is a diagram for describing chromatic dispersion control according to the fifth embodiment.

### DESCRIPTION OF EMBODIMENTS

An optical waveguide formed over a silicon wafer has variations in width or height, due to variations in in-plane distribution of the wafer, variations in manufacturing process, and the like. The variations in width or height of the silicon waveguide are directly related to variations in zero-dispersion wavelength. In wavelength conversion using a semiconductor optical waveguide, it is desirable to design in consideration of the variation in in-plane distribution of the wafer, the variation in manufacturing process, and the like.

Embodiments of a wavelength conversion technology in which variations in zero-dispersion wavelength are suppressed will be described with reference to the drawings. According to the embodiment, a target zero-dispersion wavelength of an optical waveguide is, for example, an excitation optical wavelength. The zero-dispersion wavelength is a wavelength at which chromatic dispersion is 0 or minimized. A design of an optical waveguide in which the zero-dispersion wavelength is matched with the excitation optical wavelength is set as a target design. A plurality of types of optical waveguides including an optical waveguide with the target design are provided by intentionally varying the design of the optical waveguide from the target design, by assuming a manufacturing variation, a process variation, and the like. By changing the design of the optical waveguide, for example, a height, a width, a material, and the like, it is possible to gradually change a zero-dispersion wavelength of each waveguide from the target zero-dispersion wavelength. By making it possible to select an optical waveguide at which wavelength conversion efficiency is maximized among these optical waveguides, an optimum optical waveguide at which chromatic dispersion is minimized is used by absorbing the process variation, for example, a variation for each wafer or the manufacturing variation, for example, an in-plane variation of the wafer.

### System Configuration

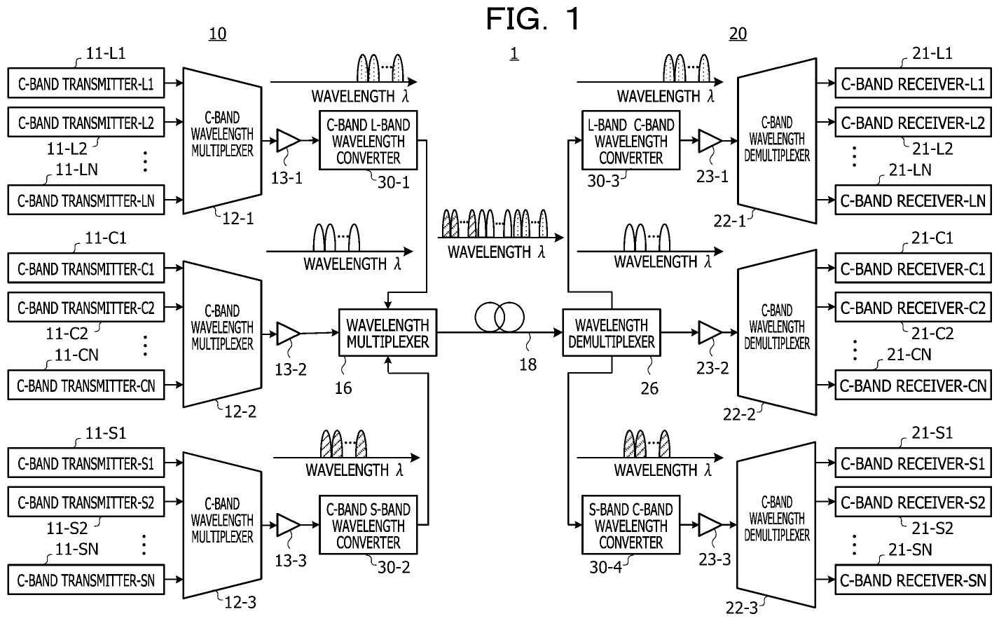

FIG. 1 is a schematic diagram of an optical transmission system 1 using a wavelength converter 30 according to the embodiment. The optical transmission system 1 includes an optical communication apparatus 10 on a transmission side, an optical communication apparatus 20 on a reception side, and an optical transmission line 18 coupling these optical communication apparatuses 10 and 20. The optical communication apparatus 10 and the optical communication apparatus 20 have both a transmission function and a reception function, and have the same configuration. For the sake of explanation, the function on the transmission side of the optical communication apparatus 10 and the function on the reception side of the optical communication apparatus 20 are described as an example. Both of the optical communication apparatuses 10 and 20 have a configuration described in the optical communication apparatus 10 as an optical transmitter, and have a configuration described in the optical communication apparatus 20 as an optical receiver.

The optical communication apparatus 10 includes optical transmitters 11-L1 to 11-LN, optical transmitters 11-C1 to 11-CN, and optical transmitters 11-S1 to 11-SN (hereinafter, collectively referred to as an “optical transmitter 11” as appropriate). These optical transmitters 11 are, for example, photoelectric conversion front end circuits of an optical transponder. A plurality of optical transmitters 11 have the same configuration, and output signals having, for example, a wavelength channel of a C-band (1530 to 1565 nm) (which are referred to as “C-band transmitters” in FIG. 1).

Output light beams from the optical transmitters 11-L1 to 11-LN are multiplexed by a first wavelength multiplexer 12-1. Output light beams from the optical transmitters 11-C1-to 11-CN are multiplexed by a second wavelength multiplexer 12-2. Output light beams from the optical transmitters 11-S1 to 11-SN are multiplexed by a third wavelength multiplexer 12-3. The first wavelength multiplexer 12-1, the second wavelength multiplexer 12-2, and the third wavelength multiplexer 12-3 have the same function and configuration, and multiplex the input signals having a plurality of wavelength channels and output the resultant signal.

The output of the first wavelength multiplexer 12-1 is amplified by a first optical amplifier 13-1, is wavelength-converted by a first wavelength converter 30-1, and is incident on a wavelength multiplexer 16. In this example, C-band signal light is collectively converted into L-band signal light by the first wavelength converter 30-1. The output of the second wavelength multiplexer 12-2 is amplified by a second optical amplifier 13-2, and is incident on the wavelength multiplexer 16 as it is.

The output of the third wavelength multiplexer 12-3 is amplified by a third optical amplifier 13-3, is wavelength-converted by a second wavelength converter 30-2, and is incident on the wavelength multiplexer 16. In this example, C-band signal light is collectively converted into S-band signal light by the second wavelength converter 30-2. The first optical amplifier 13-1, the second optical amplifier 13-2, and the third optical amplifier 13-3 have the same function and configuration, and amplify the multiplexed C-band signal light.

The wavelength multiplexer 16 multiplexes the L-band signal light, the C-band signal light, and the S-band signal light, and outputs a WDM signal to an optical transmission line 18. Wavelength channels from an L-band to an S-band are included in the WDM signal, and optical communication over a wide-bandwidth is performed. The WDM signal is propagated through the optical transmission line 18, and is received by the optical communication apparatus 20.

In the optical communication apparatus 20, the received optical signal is demultiplexed into L-band signal light, C-band signal light, and S-band signal light by a wavelength demultiplexer 26. The L-band signal light is converted to C-band signal light by a third wavelength converter 30-3, is amplified by an optical amplifier 23-1, and is demultiplexed into wavelength channels different from each other by a first wavelength demultiplexer 22-1.

The S-band signal light is converted to C-band signal light by a fourth wavelength converter 30-4, is amplified by an optical amplifier 23-3, and is demultiplexed into wavelength channels different from each other by a third wavelength demultiplexer 22-3. The C-band signal light is amplified by an optical amplifier 23-2 as it is without wavelength conversion, and is demultiplexed into wavelength channels different from each other by a second wavelength demultiplexer 22-2. The optical amplifiers 23-1 to 23-3 have the same function and configuration. The first wavelength demultiplexer 22-1 to the third wavelength demultiplexer 22-3 have the same function and configuration, and demultiplex C-band signal light into wavelength channels different from each other.

The respective signal light beams demultiplexed by the first wavelength demultiplexer 22-1 are supplied to optical receivers 21-L1 to 21-LN. The respective signal light beams demultiplexed by the second wavelength demultiplexer 22-2 are supplied to optical receivers 21-C1 to 21-CN. The respective signal light beams demultiplexed by the third wavelength demultiplexer 22-3 are supplied to optical receivers 21-S1 to 21-SN. The optical receivers 21-L1 to 21-LN, the optical receivers 21-C1 to 21-CN, and the optical receivers 21-S1 to 21-SN are collectively referred to as an “optical receiver 21” as appropriate.

These optical receivers 21 are, for example, photoelectric conversion front end circuits of an optical transponder. A plurality of optical receivers 21 have the same configuration, and convert light having, for example, a wavelength channel of the C-band (1530 to 1565 nm) to an electrical signal.

This optical transmission system 1 does not use optical components for individual bandwidths, and uses common optical transceivers, wavelength multiplexers and demultiplexers, optical amplifiers, and the like. As will be described below, each of the first wavelength converter 30-1 to the fourth wavelength converter 30-4 has a configuration in which a variation in in-plane distribution of a wafer, a process variation, and the like are suppressed, and deterioration in transfer performance due to a variation in zero-dispersion wavelength or a deviation from an excitation optical wavelength is suppressed.

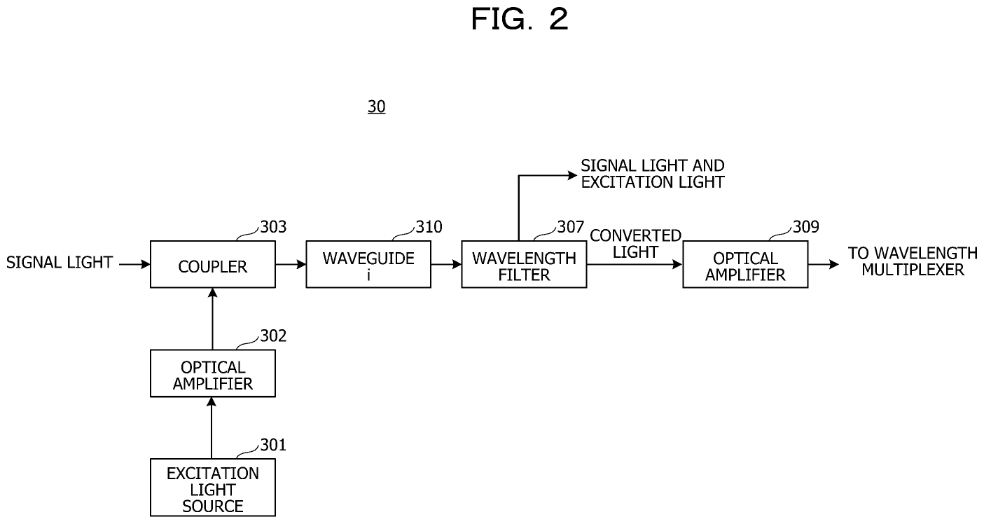

FIG. 2 is a basic configuration diagram of the wavelength converter 30 according to the embodiment. The wavelength converter 30 includes an excitation light source 301, an optical amplifier 302, a coupler 303, an optical waveguide substrate 310 on which a plurality of optical waveguides are formed, a wavelength filter 307, and an optical amplifier 309. Light emitted from the excitation light source 301 is amplified by the optical amplifier 302, is multiplexed with signal light by the coupler 303, and is incident on the optical waveguide substrate 310. It is not desirable to provide the excitation light source 301, the optical amplifier 302, and the coupler 303, and signal light and excitation light may be multiplexed outside the wavelength converter 30.

A plurality of optical waveguides having gradually different design values are formed in the optical waveguide substrate 310, and an i-th optical waveguide having the highest wavelength conversion efficiency or the lowest chromatic dispersion is used for wavelength conversion. The plurality of optical waveguides are nonlinear optical media formed at a semiconductor such as silicon. When signal light is incident on an optical waveguide i together with excitation light having a sufficient intensity, the incident light and silicon that is a nonlinear optical medium interact with each other to generate a new frequency component. This new frequency component is converted light.

Light emitted from the optical waveguide substrate 310 includes signal light, excitation light, and converted light. The wavelength filter 307 removes the signal light and the excitation light, and outputs the converted light. The converted light is amplified by the optical amplifier 309, and is supplied to, for example, the wavelength multiplexer 16 (see FIG. 1).

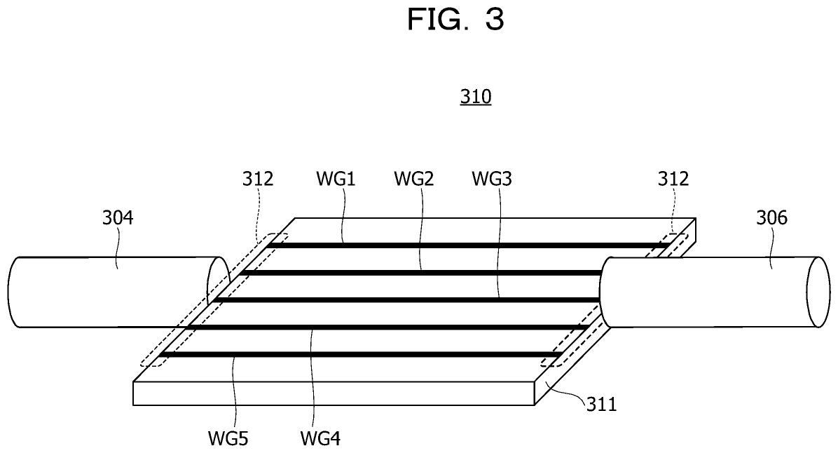

FIG. 3 is a schematic diagram illustrating the optical waveguide substrate 310. In the optical waveguide substrate 310, a plurality of optical waveguides WG1 to WG5 are formed in a substrate 311. As an example, the optical waveguides WG1 to WG5 are strip-type silicon waveguides formed over a silicon oxide film. A nonlinear coefficient of silicon is higher than a nonlinear coefficient of an optical fiber, and wavelength conversion with a propagation length of several centimeters may be performed.

Signal light and excitation light are incident from the optical fiber 304 over any of the optical waveguides over the optical waveguide substrate 310. Converted light is generated by a nonlinear optical effect in the selected optical waveguide, and the converted light, the signal light, and the excitation light are emitted from the optical waveguide substrate 310. The emitted light is guided to the wavelength filter 307 by an optical fiber 306.

The optical waveguides WG1 to WG5 of the optical waveguide substrate 310 have zero-dispersion wavelengths slightly different from each other. One of the optical waveguides WG1 to WG5 may be designed to have a target zero-dispersion wavelength. The zero-dispersion wavelength is a wavelength at which an optical signal may be propagated without causing wavelength distortion, and the target dispersion wavelength is set to, for example, an excitation optical wavelength. A difference in zero-dispersion wavelength between the optical waveguides WG is given by design such as a width, a height, and a material of the optical waveguide. Even in a case where variations occur in in-plane distribution of a wafer or there are process variations, signal transmission characteristics are appropriately maintained by selecting, among the plurality of optical waveguides WG1 to WG5, an optical waveguide that minimizes chromatic dispersion, for example, that maximizes conversion efficiency of the signal light, for each optical waveguide substrate 310 cut into a chip.

An optical coupling structure 312 is provided between the optical fiber 304 and an incidence side of the optical waveguide substrate 310 and between an emission side of the optical waveguide substrate 310 and the optical fiber 306, in order to couple the optical fibers 304 and 306 to an optimum optical waveguide having minimum chromatic dispersion. The optical coupling structure 312 may be a spatial optical system using a lensed fiber, or may be a mode converter (or a spot size converter) provided at an edge of the optical waveguide substrate 310. In a case where the mode converter is formed at the edge of the optical waveguide substrate 310, the optical fibers 304 and 306 may be held by a V-groove substrate, and may be coupled to an end surface of the optical waveguide WG of the optical waveguide substrate 310.

Hereinafter, a specific example of selecting an optimum optical waveguide will be described. In the embodiment, there is a case where the same components are denoted by the same reference signs, and redundant description thereof may be omitted. The disclosed technology of the present disclosure is not limited by each of embodiments, which will be described below. Each of the embodiments, which will be described below may be appropriately combined within a range in which no contradiction occurs.

### First Embodiment

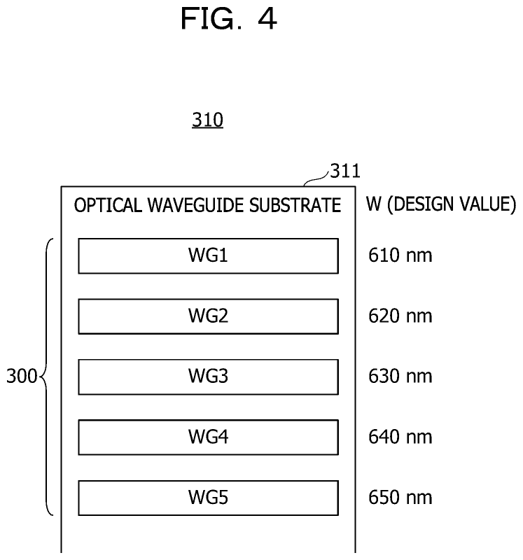

FIG. 4 illustrates a design example of an optical waveguide substrate according to a first embodiment. The optical waveguide substrate 310 includes the optical waveguides WG1 to WG5 formed in the substrate 311. The optical waveguides WG1 to WG5 are collectively referred to as an optical waveguide group 300. Although heights of the optical waveguides WG1 to WG5 are designed to have the same value, for example, 220 nm in the first embodiment, design values of widths W are different from each other.

The width W of the optical waveguide WG1 is designed to be 610 nm. The width W of the optical waveguide WG2 is designed to be 620 nm. The widths W of the optical waveguides WG3, WG4, and WG5 are respectively designed to be 630 nm, 640 nm, and 650 nm. When the completed width W of the optical waveguide WG is designed as 630 nm, five types of optical waveguides WG1 to WG5 are formed by respectively changing the widths W by 10 nm on a plus side and a minus side, on the assumption that variations due to a waveguide formation process are unknown. Since the widths W are different from each other at the same height, zero-dispersion wavelengths of the optical waveguides WG1 to WG5 are slightly different from each other.

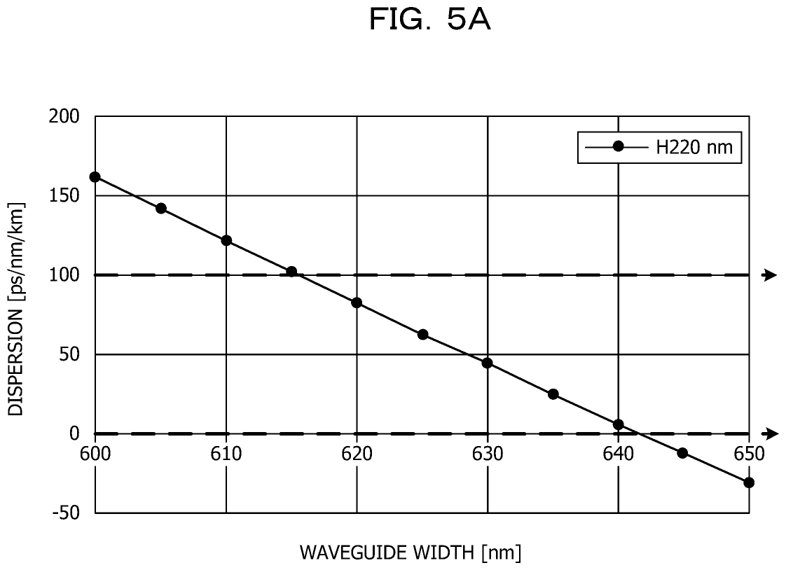

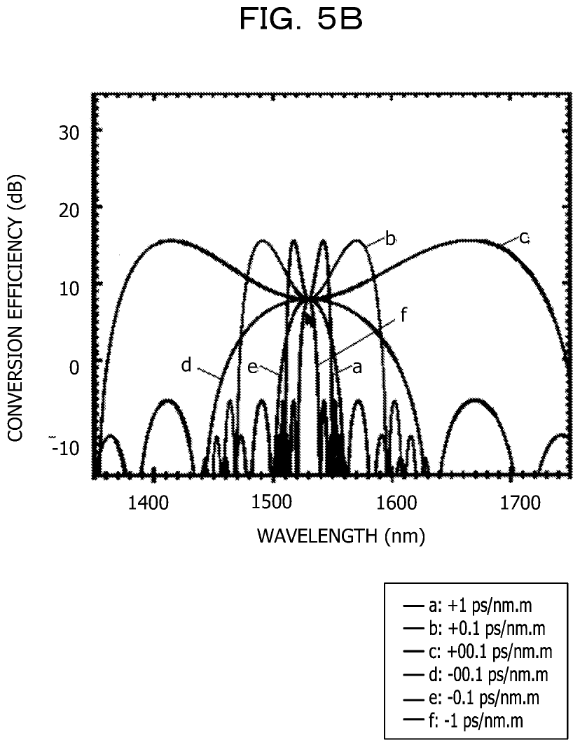

FIG. 5A illustrates dispersion characteristics with respect to the width W of the optical waveguide WG when a wavelength of excitation light is set to 1522 nm. A standard height H of the optical waveguide WG is fixed to 220 nm. As an example, the optical waveguide substrate 310 illustrated in FIG. 4 allows dispersion of −50 ps/nm/km or more and 100 ps/nm/km or less (for example, −0.05 ps/nm/m or more and 0.1 ps/nm/m or less) since a propagation length for realizing wavelength conversion is as short as several centimeters. A reason why a range of positive dispersion is widened is to keep a bandwidth wide by excluding dispersion that does not satisfy a phase matching condition. A range of this dispersion is based on FIG. 5B.

FIG. 5B illustrates conversion efficiencies of various dispersion values. Among wavelengths on the horizontal axis, dispersion indicating an allowable conversion efficiency over a range from 1480 nm to 1600 nm is +0.1 ps/nm/m (line b), +0.01 ps/nm/m (line c), and −0.01 ps/nm/m (line d). As an absolute value of the dispersion decreases, the conversion efficiency increases.

A phase matching condition in which the nonlinear effect is involved is expressed as follows.

Δk_{NL}=2γPp−Δk_{L}

Δk indicates a mismatch of wave numbers (for example, phases), NL with a subscript indicates a nonlinear term, and L indicates a linear term. γ is a nonlinear coefficient of a medium, and has a positive value in most media including silicon. Pp is excitation light power. By setting the phase matching condition to 0, wide-bandwidth wavelength conversion is realized.

The linear term is expressed by polynomial expansion as follows.

Δk_{L}=−β₂(Δω)²−β₄(Δω⁴/12

Assuming that fourth-order dispersion β₄ is zero (0), the linear term is expressed as follows.

Δk_{L}=−β₂(Δω)²

For (Δk_{NL}=0) satisfying the phase matching condition, Δk_{L}=−β₂(Δω)² is desirable to be as close to 0 as possible.

Meanwhile, a relationship between the second-order dispersion β₂ and dispersion D is known to be D=−(2πc/λ²)β₂. c is a speed of light, and λ is a wavelength of excitation light. When the second-order dispersion β₂ is 0 or minimum in order to satisfy the phase matching condition, it is desirable that the dispersion D is also 0 or minimum. As the dispersion D deviates from 0, the phase matching condition is not satisfied, and a wavelength conversion bandwidth is narrowed. Although the phase matching condition is satisfied in a wide range of an excitation optical wavelength in a case where the excitation optical wavelength coincides with a zero-dispersion wavelength of the optical waveguide WG, the wavelength bandwidth in which wavelength conversion may be performed is limited when the phase matching condition is not satisfied.

In the example in FIG. 5A, dispersion generated when the width W of the optical waveguide is 615 nm to 640 nm is within an allowable range. Among the optical waveguides, by selecting the optical waveguide WG4 having the width W of 640 nm, the dispersion is minimized. As the dispersion D is minimized, the second-order dispersion β₂ is minimized, and a deviation from the phase matching condition is minimized. Even in a case where variations in waveguide formation process or in-plane distribution of a wafer occur in the optical waveguide substrate 310, it is possible to stabilize transmission characteristics by minimizing variation in zero-dispersion wavelength between chips.

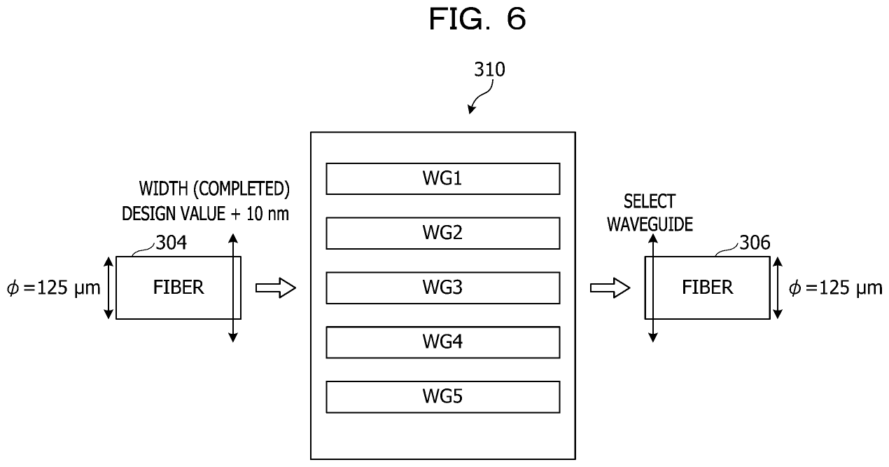

FIG. 6 illustrates an example of selecting an optical waveguide. Diameters of the optical fibers 304 and 306 are 125 μm. Cores of the optical fibers 304 and 306 are coupled to the selected optical waveguide WG via the optical coupling structure 312 (see FIG. 3). For example, by selecting the optical waveguide WG4 designed with +10 nm with respect to the completed design value 630 nm of the width W of the optical waveguide, wavelength conversion is performed with minimum chromatic dispersion.

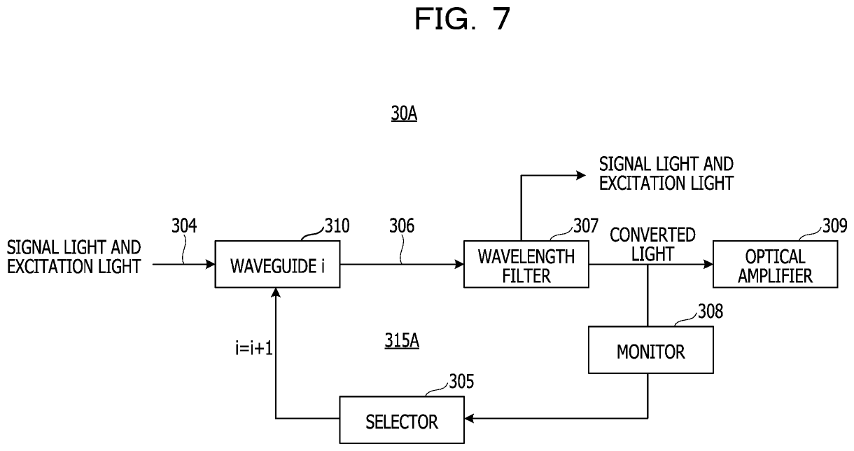

FIG. 7 is a schematic diagram illustrating a wavelength converter 30A incorporating an optical waveguide selection circuit 315A. By changing a coupling position of the optical fiber 304 and the optical fiber 306, light including signal light having a wavelength of 1530 nm to 1560 nm and excitation light having a wavelength of 1522 nm is sequentially incident on each of the optical waveguides WG of the optical waveguide substrate 310. A part of idler light (converted light) after the signal light and the excitation light are removed by the wavelength filter 307 is branched, and output power of the converted light is measured by the monitor 308. The optical waveguide WG when the output power of the idler light is maximized is selected and set by a selector 305. Even in a case where a width of an optical waveguide deviates from a completed design value due to variations in a waveguide formation process or in-plane distribution of a wafer, an optical waveguide (for example, WG4) that maximizes the output power of the converted light may be selected to bring a characteristic of the optical waveguide close to a propagation characteristic of an excitation optical wavelength, which is a design target.

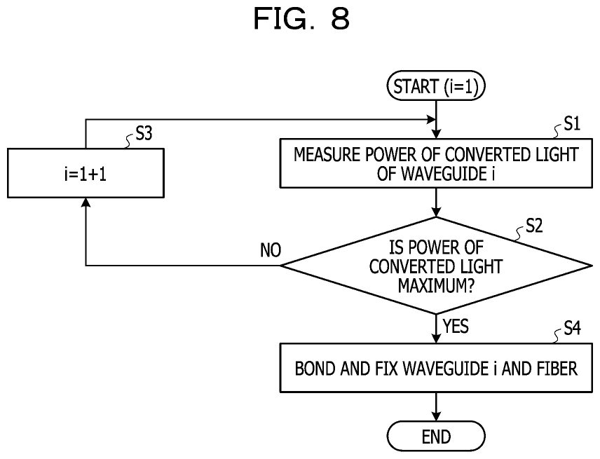

FIG. 8 is a flowchart of selecting an optical waveguide according to the circuit configuration illustrated in FIG. 7. The selection of the optical waveguide is performed in the assembly of the wavelength converters 30, an adjustment test, and the like. At a start of the optical waveguide selection flow, a number i of the optical waveguide is initialized to 1. The optical fibers 304 and 306 are coupled to the optical waveguide WG1, signal light and excitation light are incident on the optical waveguide WG1, and power of converted light is measured by the monitor 308 (S1). Whether or not the power of the converted light is maximum is determined (S2). Until the power of the converted light is maximized (Yes in S2), the number i of the optical waveguides is incremented, and the measurement of the converted light and the power determination are repeated. After S3 and S1 are sequentially repeated for all the optical waveguides and the measurement results are stored in a memory, determination in S2 may be performed. Alternatively, a measured value immediately before the measured value decreases after an increase in the measured value continues may be set as the maximum value.

The optical fibers 304 and 306 are bonded and fixed to the optical waveguide in which the power of the converted light is maximized (S4), and the selection of the waveguide is completed.

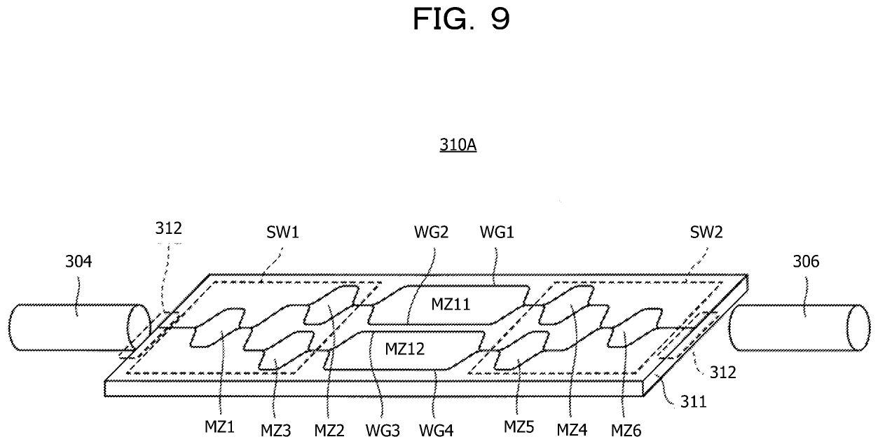

FIG. 9 is a schematic diagram illustrating an optical waveguide substrate 310A including the optical switches SW1 and SW2. The optical waveguide substrate 310A includes the four optical waveguides WG1 to WG4 having zero-dispersion wavelengths different from each other. The optical waveguides WG1 and WG2 form a Mach-Zehnder interferometer MZ11, and the optical waveguides WG3 and WG4 form a Mach-Zehnder interferometer MZ12.

The optical switch SW1 is a 1-input 4-output optical switch. As a configuration example of the 1-input 4-output optical switch, a tree structure in which Mach-Zehnder type optical waveguides MZ2 and MZ3 are coupled to two output ports of a Mach-Zehnder type optical waveguide MZ1 is used. The optical switch SW2 is a 4-input 1-output optical switch. As a configuration example of the 4-input 1-output optical switch, Mach-Zehnder type optical waveguides MZ4 and MZ5 coupled to the Mach-Zehnder interferometers MZ11 and MZ12, and a Mach-Zehnder type optical waveguide MZ6 in which the Mach-Zehnder type optical waveguides MZ4 and MZ5 are merged are used. Each arm of the optical waveguides MZ1 to MZ6 is provided with a phase shifter such as a heater, and a route may be sequentially selected by control of the phase shifter.

The optical fibers 304 and 306 are coupled to the optical waveguide substrate 310A in advance via the optical coupling structure 312. Signal light and excitation light are incident on the optical waveguide substrate 310A from the optical fiber 304, routes are sequentially selected by the optical switch SW1 and the optical switch SW2, and converted light included in light output to the optical fiber 306 is monitored, so that an optimum optical waveguide is selected. Coupling states of the optical switches SW1 and SW2 are fixed such that the optical fibers 304 and 306 are optically coupled to the selected optical waveguide.

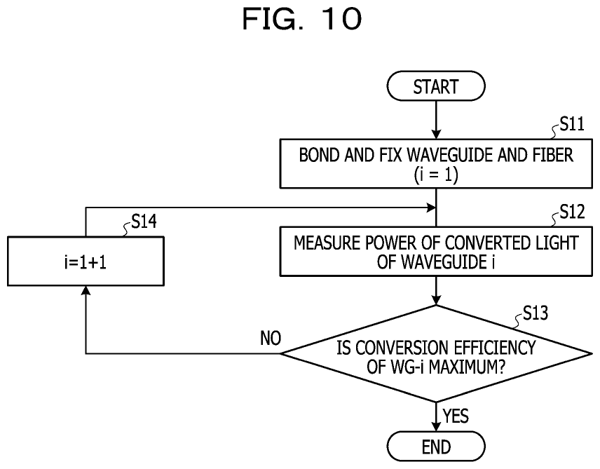

FIG. 10 is a flowchart of selecting an optical waveguide according to the configuration illustrated in FIG. 9. The optical fibers 304 and 306 are bonded and fixed to an incident end and an emitting end of the optical waveguide substrate 310A (S11). At this time, the number i of the optical waveguide of the optical waveguide substrate 310 is initialized to 1. A phase shifter provided in the Mach-Zehnder type optical waveguides MZ1 to MZ3 included in the optical switch SW1 is controlled such that incident light from the optical fiber 304 propagates through the optical waveguide WG1. Assuming a finite extinction ratio, when the optical waveguide WG1 is selected, propagation of light to another optical waveguide is not completely 0, and the propagation of light may be ignored.

Signal light and excitation light are removed from output light of the optical waveguide substrate 310A, and power of converted light at the optical waveguide WG1 is measured by the monitor 308 (S12). From the measurement spectrum, it is determined whether or not conversion efficiency of the selected optical waveguide WG1 is maximized (S13). When the conversion efficiency is maximized (Yes in S13), this means that an optimum optical waveguide having the minimum dispersion is selected, and the process is completed. When the conversion efficiency is not maximized (No in S13), the number i of the optical waveguides is incremented (S14), and S12 and S13 are repeated. According to this method, it is possible to select an optimum optical waveguide that minimizes chromatic dispersion in the switch configuration illustrated in FIG. 9.

### Second Embodiment

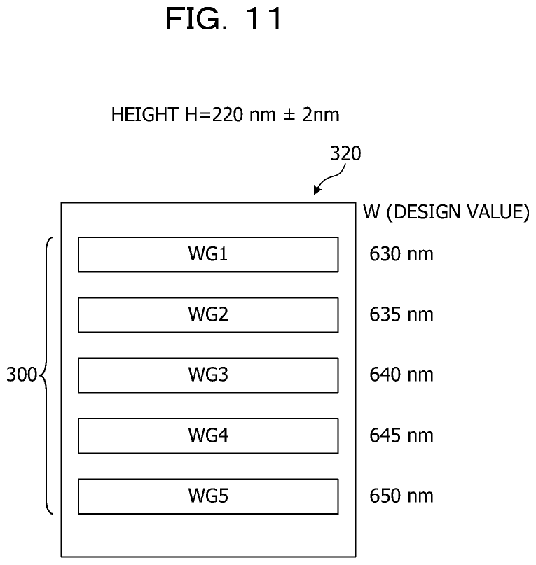

FIG. 11 illustrates a design example of an optical waveguide substrate 320 according to a second embodiment. According to the second embodiment, a case where an optical waveguide has variations in a height direction is considered. The optical waveguide substrate 320 includes the optical waveguides WG1 to WG5. The optical waveguides WG1 to WG5 are collectively referred to as the optical waveguide group 300. It is assumed that the waveguides of the optical waveguide substrate 320 have a height variation of 220 nm±2 nm. By taking this height variation into consideration, the optical waveguides WG1 to WG5 with which design values of the width W are set to 630 nm, 635 nm, 640 nm, 645 nm, and 650 nm are formed, and an optical waveguide having minimum chromatic dispersion, for example, an optical waveguide having the maximum conversion efficiency is selected.

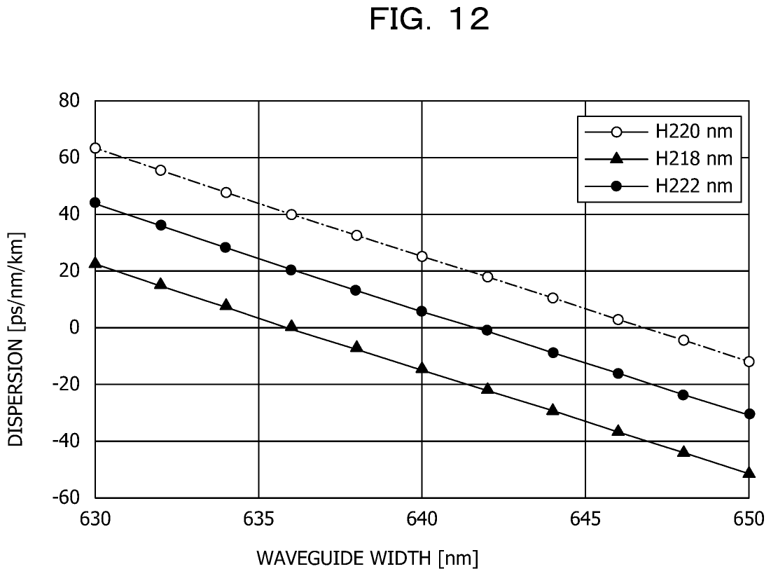

FIG. 12 illustrates dispersion characteristics of the optical waveguide WG with respect to the waveguide width W when a wavelength of excitation light is set to 1522 nm. The standard height H of the optical waveguide WG is changed to 218 nm, 220 nm, and 222 nm. It is assumed that the standard height H of an optical waveguide varies within a range of ±2 nm between different optical waveguide substrates clipped from the same wafer or optical waveguide substrates manufactured by different processes. According to the second embodiment, an optical waveguide having optimum chromatic dispersion, for example, 0 or a positive minimum value is selected from a dispersion range of ±50 ps/nm/km.

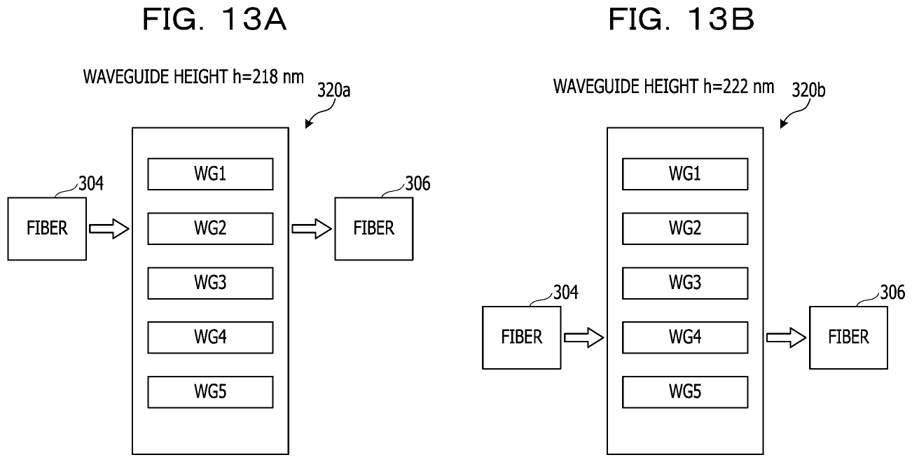

For a zero-dispersion wavelength in a waveguide substrate having the waveguide height H of 218 nm, the waveguide width W is obtained near 636 nm. For a zero-dispersion wavelength in a waveguide substrate having the waveguide height H of 222 nm, the waveguide width W is obtained near 646 nm. Accordingly, as illustrated in FIGS. 13A and 13B, in the optical waveguide substrate 320a having the standard height H of 218 nm of the optical waveguide, the optical waveguide WG2 is selected, and in the optical waveguide substrate 320b having the standard height H of 222 nm of the optical waveguide, the optical waveguide WG4 is selected. Accordingly, it is possible to maximize the bandwidth of the wavelength conversion. As described above, the optical waveguide substrate 320 and the optical fibers 304 and 306 are coupled to each other by the optical coupling structure 312 (see FIG. 3).

As described in the first embodiment, in a case where the standard height H of each optical waveguide substrate 320 is not known, light obtained by multiplexing signal light (for example, a wavelength 1530 to 1560 nm) and excitation light (a wavelength 1522 nm) is sequentially incident on each of the optical waveguides WG1 to WG5, and a bandwidth and power of idler light (converted light) are measured, so that an optimum optical waveguide may be selected.

### Third Embodiment

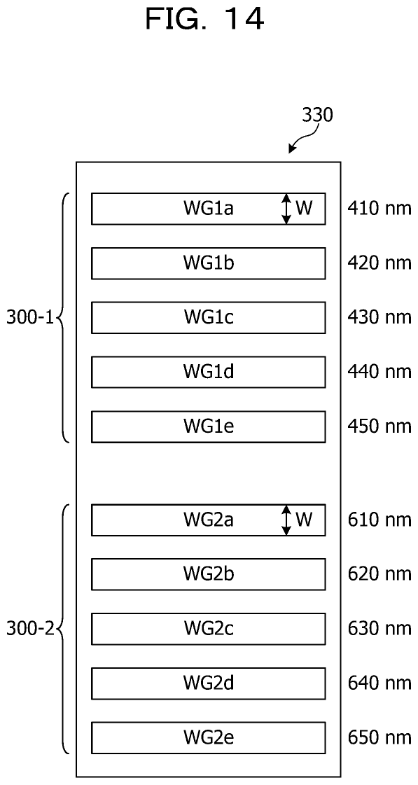

FIG. 14 is a schematic diagram of an optical waveguide substrate 330 according to a third embodiment. According to the third embodiment, a plurality of optical waveguide groups 300-1 and 300-2 are provided in the optical waveguide substrate 330. Design values of the optical waveguides WG are different between the optical waveguide groups 300-1 and 300-2. By using the optical waveguide groups 300-1 and 300-2, signal light in the same wavelength bandwidth is converted into converted light in different wavelength bands.

The first optical waveguide group 300-1 includes optical waveguides WG1a, WG1b, WG1c, WG1d, and WG1e. The widths W of the optical waveguides WG1a, WG1b, WG1c, WG1d, and WG1e are respectively designed to be 410 nm, 420 nm, 430 nm, 440 nm, and 450 nm, in accordance with a first excitation optical wavelength (for example, 1567 nm). All the heights H of the optical waveguides are designed to be 220 nm. The first excitation optical wavelength may be set as a first target zero-dispersion wavelength.

The second optical waveguide group 300-2 includes optical waveguides WG2a, WG2b, WG2c, WG2d, and WG2e. The widths W of the optical waveguides WG2a, WG2b, WG2c, WG2d, and WG2e are respectively designed to be 610 nm, 620 nm, 630 nm, 640 nm, and 650 nm, in accordance with a second excitation optical wavelength (for example, 1522 nm). All the heights H of the optical waveguides are designed to be 220 nm. The second excitation optical wavelength may be set as a second target zero-dispersion wavelength.

In the first optical waveguide group 300-1, excitation light having a wavelength of 1567 nm and signal light (for example, a wavelength of 1530 to 1560 nm) are incident and converted light is monitored, so that it is possible to select an optimum optical waveguide, for example, an optical waveguide that minimizes chromatic dispersion. In the second optical waveguide group 300-2, excitation light having a wavelength of 1522 nm and signal light (for example, a wavelength of 1530 to 1560 nm) are incident and converted light is monitored, so that it is possible to select an optimum optical waveguide.

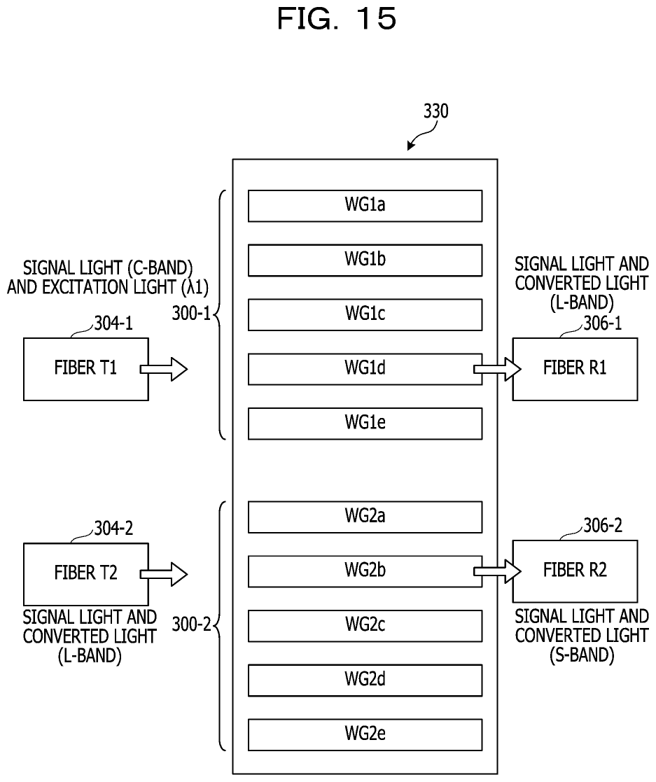

In the example in FIG. 15, the optical waveguide WG1d is selected in the first optical waveguide group 300-1. An optical fiber 304-1 is coupled to the optical waveguide WG1d, signal light in a C-band and excitation light having a wavelength λ1 (1567 nm) are incident on the optical waveguide WG1d, and light including converted light in an L-band is emitted to the optical fiber 306-1. The optical waveguide WG2b is selected in the second optical waveguide group 300-2. An optical fiber 304-2 is coupled to the optical waveguide WG2b, signal light in the C-band and excitation light having the wavelength λ2 (1522 nm) are incident on the optical waveguide WG2b, and light including converted light in an S-band is emitted to the optical fiber 306-2.

According to the configuration of the third embodiment, it is possible to obtain converted light having different wavelengths in one optical waveguide substrate 330.

### Fourth Embodiment

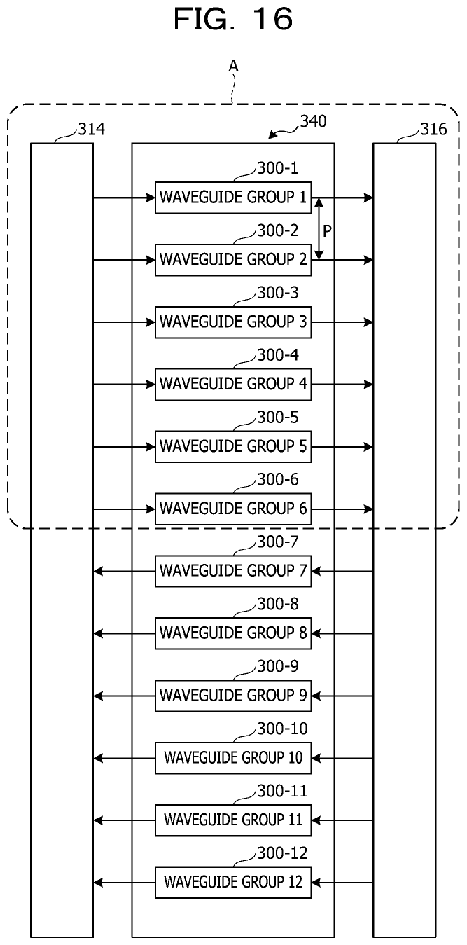

FIG. 16 is a schematic diagram of an optical waveguide substrate 340 according to a fourth embodiment. According to the fourth embodiment, multi-core fibers 314 and 316 having fixed pitches are used. In the same manner as the third embodiment, a plurality of optical waveguide groups 300-1 to 300-12 are formed in the optical waveguide substrate 340. The optical waveguide groups 300-1 to 300-6 are used for transmission, and the optical waveguide groups 300-7 to 300-12 are used for reception. In the same manner as the first embodiment to the third embodiment, a plurality of optical waveguides having different design values are formed in each optical waveguide group 300. As an example, a design value of the width W of the optical waveguide is changed such that a zero-dispersion wavelength gradually differs between the plurality of optical waveguides.

Since the pitch of the optical fibers is fixed in the multi-core fibers 314 and 316, it is difficult to select an optical waveguide having the minimum chromatic dispersion and couple the selected optical waveguide to the optical fiber. Accordingly, the plurality of optical waveguides are provided in each optical waveguide group 300, based on a predetermined rule.

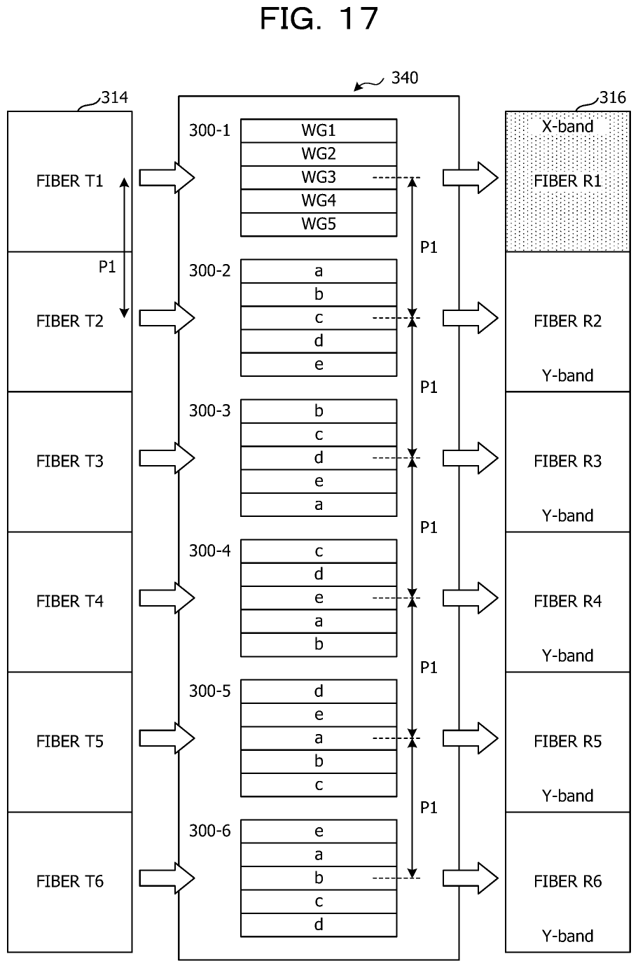

FIG. 17 illustrates an arrangement example of optical waveguides according to a configuration A on a transmission side in FIG. 16. The optical waveguide groups 300-1 to 300-6 are provided respectively corresponding to optical fibers T1 to T6 included in the multi-core fiber 314 and optical fibers R1 to R6 included in the multi-core fiber 316.

The plurality of optical waveguides WG1 to WG5 or a plurality of optical waveguides a to e are included in each of the optical waveguide groups 300-1 to 300-6. A pitch between the optical fiber of the multi-core fiber 314 and the optical fiber of the multi-core fiber 316 is fixed to P1 (for example, 250 μm). The optical waveguide groups 300-1 to 300-6 are formed such that a pitch between the adjacent optical waveguide groups 300 is equal to or smaller than P1, and arrangement orders of the plurality of optical waveguides between the optical waveguide groups 300-1 to 300-6 are different from each other.

In the optical waveguide group 300-1, any one of the optical waveguides WG1 to WG5 is selected, and is used for wavelength conversion into a first wavelength bandwidth (for example, an L-band). Any one of the optical waveguides a to e is selected in any one of the optical waveguide groups 300-2 to 300-6, and is used for wavelength conversion into a second wavelength bandwidth (for example, an S-band).

When the optical fibers T1 and T2 are coupled to any of the optical waveguides WG1 to WG5, positions of the optical fibers T2 to T3 and the optical fibers R2 to R6 with respect to the optical waveguide groups 300-2 to 300-6 are displaced. Even when the relative position of the optical fiber with respect to the optical waveguide group 300 is displaced, the arrangement order of the optical waveguides a to e is rearranged in the optical waveguide groups 300-2 to 300-6 such that an optimum optical waveguide is selected.

In the optical waveguide group 300-2, the optical waveguides are arranged in the order of a, b, c, d, and e. In the optical waveguide group 300-3, the optical waveguides are arranged in the order of b, c, d, e, and a. In the optical waveguide group 300-4, the optical waveguides are arranged in the order of c, d, e, a, and b. In the optical waveguide group 300-5, the optical waveguides are arranged in the order of d, e, a, b, and c. In the optical waveguide group 300-6, the optical waveguides are arranged in the order of e, a, b, c, and d.

By rearranging the arrangement of the optical waveguides, the optical fibers T and R are coupled to optimum optical waveguides in any one of the optical waveguide groups 300-2 to 300-6. Even in a case where the multi-core fibers 314 and 316 having fixed pitches are used, both the wavelength conversion into the first wavelength bandwidth and the wavelength conversion into the second wavelength bandwidth may be realized with minimum dispersion by one optical waveguide substrate 340.

A rule for arranging the optical waveguides according to the fourth embodiment is as follows.

(1) For a zero-dispersion wavelength (for example, an excitation optical wavelength) of one target, the number of optical waveguides included in one optical waveguide group (for example, the number of changes in the optical waveguide WG) is determined such that a pitch between the adjacent optical waveguide groups 300 is equal to or smaller than a fixed pitch (for example, 250 μm) of the multi-core fibers 314 and 316. For example, the number of optical waveguides WG included in the optical waveguide group 300-1 and the number of optical waveguides included in each of the optical waveguide groups 300-2 to 300-6 are determined such that a distance between a center of the optical waveguide group 300-1 in an arrangement direction and an arrangement center of the optical waveguide group 300-2 is equal to or smaller than 250 μm. In this example, the number of changes in the optical waveguide WG is 5.

(2) In a case where two or more wavelength conversions are performed in one optical waveguide substrate 340, the number of optical waveguides formed in the waveguide substrate is as follows.

(number of changes in optical waveguide group)\hat{ }(number of wavelength conversions)+(number of changes in optical waveguide group)

The symbol “\hat{ }” is an operator that performs exponentiation.

In the example illustrated in FIG. 17, since the number of changes in a design value included in the optical waveguide group 300 is 5 and the number of wavelength conversions is 2, a total of 30 optical waveguides are formed with 5²+5.

(3) The number of optical fibers coupled to an incidence side and an emission side of the optical waveguide substrate 340 is as follows.

(number of changes in optical waveguide group)\hat{ }(number of wavelength conversions−1)+1

In the example illustrated in FIG. 17, since the number of changes in a design value included in the optical waveguide group 300 is 5 and the number of wavelength conversions is 2, six optical fibers are coupled on each of an incidence side and an emission side with 5¹+1.

(4) In order to obtain converted light converted into light in a second wavelength bandwidth, from any channel of the optical fibers R2 to R6, a pattern of changes in the waveguide width W is rearranged in the optical waveguide groups 300-2 to 300-6.

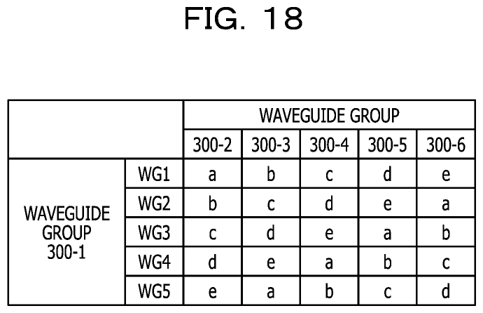

FIG. 18 is a diagram for describing selection of an optical waveguide in the optical waveguide substrate 340 illustrated in FIG. 16. Depending on which optical waveguide of the optical waveguides WG1 to WG5 is selected in the optical waveguide group 300-1, which optical waveguide is coupled to the optical fiber T or R in the optical waveguide groups 300-2 to 300-6 is determined.

For example, in a case where the optical waveguide WG4 is selected in the optical waveguide group 300-1, the optical waveguide d is coupled to the optical fiber T2 in the optical waveguide group 300-2, and the optical waveguide e is coupled to the optical fiber T3 in the optical waveguide group 300-2. The optical waveguide a is coupled to the optical fiber T3 in the optical waveguide group 300-4, the optical waveguide b is coupled to the optical fiber T5 in the optical waveguide group 300-5, and the optical waveguide c is coupled to the optical fiber T6 in the optical waveguide group 300-6.

By selecting an optical fiber coupled to an optical waveguide having optimum chromatic dispersion characteristics among the optical fibers T2 to T6 and the optical fibers R2 to R6, it is possible to maximize conversion efficiency for the second wavelength bandwidth.

The configuration of the fourth embodiment is useful in a case where wavelength conversion into a plurality of wavelength bands is performed with one optical waveguide substrate by using a multi-core fiber.

### Fifth Embodiment

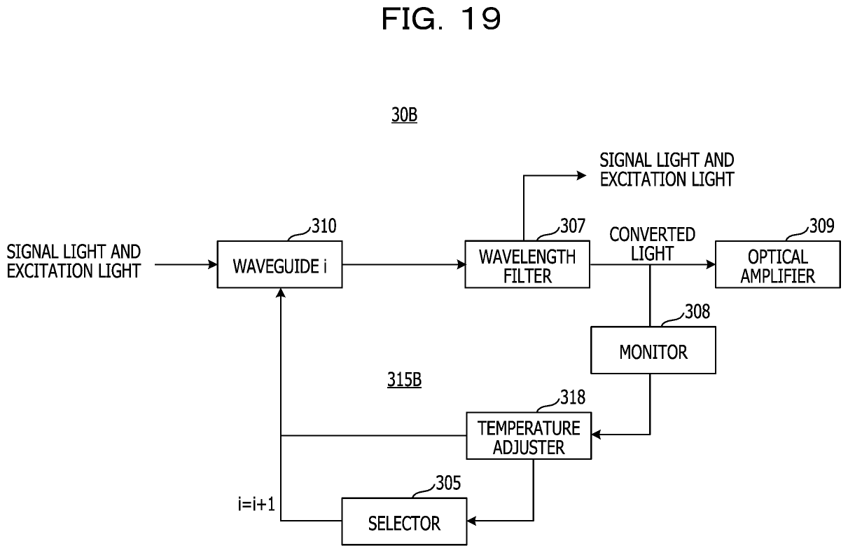

FIG. 19 is a schematic diagram of a wavelength converter 30B according to a fifth embodiment. The wavelength converter 30B includes an optical waveguide selection circuit 315B. The optical waveguide selection circuit 315B combines external chromatic dispersion control when selecting an optical waveguide having an optimum chromatic dispersion characteristic, among optical waveguides formed in the optical waveguide substrate 310.

The optical waveguide selection circuit 315B includes a monitor 308 that monitors a part of converted light, a selector 305 that selects an optical waveguide in accordance with an output of the monitor 308, and a temperature adjuster 318 that controls a temperature of the optical waveguide in accordance with the output of the monitor 308. The temperature adjuster 318 is used to control a zero-dispersion wavelength of each optical waveguide. Even in a case where an optical waveguide having an optimum chromatic dispersion characteristic (for example, maximum conversion efficiency) is selected, chromatic dispersion may remain in the selected optical waveguide. In this case, by adjusting a chromatic dispersion characteristic of another optical waveguide by the temperature adjuster 318, the zero-dispersion may be closer to a target zero-dispersion.

Since silicon has temperature dependence of a refractive index, the chromatic dispersion characteristic is shifted by giving a temperature change to the optical waveguide. For example, in the optical waveguide substrate 310 illustrated in FIG. 3, thin film heaters are formed on both sides of the optical waveguides WG1 to WG5 in a propagation direction, and the thin film heaters are heated by being energized. In a case where local chromatic dispersion control is performed, asymmetric thin film heaters may be formed on the both sides of the optical waveguide WG.

The optical waveguide is designed such that a chromatic dispersion characteristic at a room temperature of the adjacent optical waveguide WG is included between a chromatic dispersion characteristic at a room temperature of each optical waveguide WG and a chromatic dispersion characteristic at a time of temperature control.

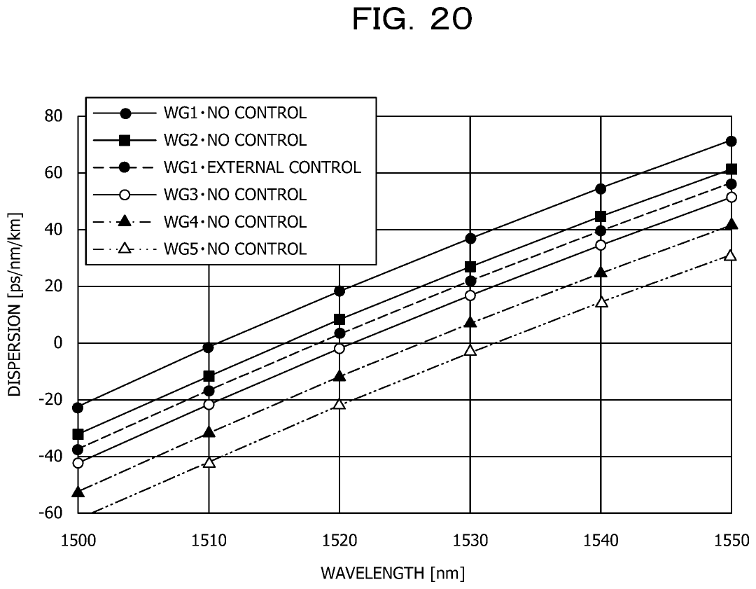

FIG. 20 is a diagram for describing chromatic dispersion control according to a fifth embodiment. A target zero-dispersion wavelength is set to 1520 nm. Although the optical waveguide WG2 is selected as an optimum optical waveguide within a range of dispersion that realizes a predetermined bandwidth in a case where temperature control is not performed, a certain degree of chromatic dispersion remains.

Meanwhile, when the temperature of the optical waveguide WG1 is controlled, a chromatic dispersion characteristic of the optical waveguide WG1 is shifted in a direction in which the dispersion decreases, and the chromatic dispersion of the optical waveguide WG2 approaches zero-dispersion at the target zero-dispersion wavelength. Referring to FIG. 20, the chromatic dispersion characteristic is shifted from a chromatic dispersion characteristic of “WG1 no control” indicated by a black circle and a solid line to a chromatic dispersion characteristic of “WG1 external control” indicated by a black circle and a dotted line. By performing the temperature control, it is possible to obtain a chromatic dispersion characteristic better than the chromatic dispersion characteristic of the selected optical waveguide WG2 (“WG2 no control” indicated by black squares and a solid line).

For each optical waveguide WG, a chromatic dispersion characteristic at a room temperature and at a time of temperature control may be measured in advance, and stored in a memory or the like. Based on the output of the monitor 308 and information on the chromatic dispersion characteristic of each optical waveguide stored in the memory, the optical waveguide selection circuit 315B causes the selector 305 to select the optical waveguide WG1, and causes the temperature adjuster 318 to control a temperature of the optical waveguides WG1, so that an optimum chromatic dispersion characteristic is realized.

Hereinbefore, the present disclosure is described based on the specific embodiments, and the present disclosure is not limited to the above configuration examples. The plurality of optical waveguides formed in the optical waveguide substrate are not limited to the strip-type optical waveguides, and may be ridge-type optical waveguides. Alternatively, the optical waveguide may be a waveguide having a rectangular cross-sectional shape surrounded by a cladding of a silicon oxide film or a rib-type optical waveguide. In a case where the ridge-type optical waveguide is used, the zero-dispersion wavelength may be made different by changing a ridge width, a ridge height, or a material (refractive index). Also in a case where the rib-type optical waveguide is used, the zero-dispersion wavelength may be made different by changing a rib width, a rib height, and a material (refractive index).

In a case where the optical switch is provided in the optical waveguide substrate, the optical switch is not limited to the MZ type optical switch, and a multimode interferometer (MMI) type optical switch, a switch in which a plurality of MMI type optical switches are combined, or the like may be used. The number of optical waveguides having different design values included in one optical waveguide group is not limited to five. One optical waveguide group may be formed by three or seven optical waveguides within a range in which assumed process variations may be covered. In a case where the multi-core fiber is used, the number of optical waveguides included in one optical waveguide group may be appropriately determined within a range of a fixed pitch of the multi-core fiber.

In addition to the optical waveguide substrate, the incidence-side optical fiber, and the emission-side fiber, the configuration in FIG. 2 including the excitation light source, the wavelength filter, and the like may be disposed in a package to be modularized. The wavelength filter that separates converted light from signal light and excitation light may be formed in the optical waveguide substrate. An optical amplifier that amplifies the converted light may be incorporated in the optical waveguide substrate. Also in these cases, the optical fiber coupled to the emission side of the optical waveguide substrate is optically coupled to the optical waveguide having an optimum dispersion characteristic.

The configurations according to the first embodiment to the fifth embodiment may be combined as appropriate. For example, the switch configuration illustrated in FIG. 9 may be applied to the configuration for conversion into a plurality of wavelength bands according to the third embodiment (FIG. 15) or may be applied to the configuration using the multi-core fiber. In any case, even when the zero-dispersion wavelength varies due to a variation in an in-plane direction of a wafer, a variation in each process, or the like, an optimum optical waveguide may be selected for each optical waveguide substrate to perform wavelength conversion.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wavelength converter comprising:
an optical waveguide substrate configured to include a plurality of optical waveguides formed with different design values;
an incidence-side optical fiber from which signal light and excitation light are incident to the optical waveguide substrate; and
an emission-side optical fiber to which light including converted light having a wavelength different from a wavelength of the signal light is extracted from the optical waveguide substrate,
wherein the incidence-side optical fiber and the emission-side optical fiber are optically coupled to one optical waveguide among the plurality of optical waveguides.

2. The wavelength converter according to claim 1,
wherein the plurality of optical waveguides have zero-dispersion wavelengths different from each other, and in a case where a wavelength of the excitation light is set as a target zero-dispersion wavelength, an optical waveguide having a zero-dispersion wavelength closest to the target zero-dispersion wavelength is optically coupled to the incidence-side optical fiber and the emission-side optical fiber.

3. The wavelength converter according to claim 1,
wherein the optical waveguide substrate includes a first optical switch provided with an incidence side of the plurality of optical waveguides and a second optical switch provided with an emission side of the plurality of optical waveguides, and
wherein the first optical switch and the second optical switch are set such that the incidence-side optical fiber and the emission-side optical fiber are optically coupled to the one optical waveguide.

4. The wavelength converter according to claim 1,
wherein the optical waveguide substrate includes a first optical waveguide group that includes a plurality of optical waveguides having zero-dispersion wavelengths different from each other with a first target zero-dispersion wavelength and a second optical waveguide group that includes a plurality of optical waveguides having zero-dispersion wavelengths different from each other with a second target zero-dispersion wavelength different from the first target zero-dispersion wavelength.

5. The wavelength converter according to claim 4,
wherein the incidence-side optical fiber includes a first optical fiber optically coupled to a first optical waveguide having a zero-dispersion wavelength closest to the first target zero-dispersion wavelength in the first optical waveguide group and a second optical fiber optically coupled to a second optical waveguide having a zero-dispersion wavelength closest to the second target zero-dispersion wavelength in the second optical waveguide group.

6. The wavelength converter according to claim 5,
wherein the emission-side optical fiber includes a third optical fiber optically coupled to the first optical waveguide of the first optical waveguide group and a fourth optical fiber optically coupled to the second optical waveguide of the second optical waveguide group.

7. The wavelength converter according to claim 4,
wherein a first optical waveguide having a zero-dispersion wavelength closest to the first target zero-dispersion wavelength in the first optical waveguide group and a second optical waveguide having a zero-dispersion wavelength closest to the second target zero-dispersion wavelength in the second optical waveguide group are optically coupled to a multi-core fiber with a fixed pitch.

8. The wavelength converter according to claim 7,
wherein any of the first optical waveguide group and the second optical waveguide group includes a plurality of optical waveguide groups in which an arrangement order of the plurality of optical waveguides is rearranged.

9. The wavelength converter according to claim 1,
wherein widths of the plurality of optical waveguides are different from each other at predetermined spacings.

10. The wavelength converter according to claim 1,
wherein heights of the plurality of optical waveguides are different from each other at predetermined spacings.

11. The wavelength converter according to claim 1,
wherein an adjuster that changes a refractive index of the plurality of optical waveguides is provided in the plurality of optical waveguides.

12. An optical communication apparatus comprising:
a wavelength converter configured to include
an optical waveguide substrate configured to include a plurality of optical waveguides formed with different design values,
an incidence-side optical fiber from which signal light and excitation light are incident to the optical waveguide substrate, and
an emission-side optical fiber to which light including converted light having a wavelength different from a wavelength of the signal light is extracted from the optical waveguide substrate,
wherein the incidence-side optical fiber and the emission-side optical fiber are optically coupled to one optical waveguide among the plurality of optical waveguides;
an optical transmitter configured to cause the wavelength converter to convert an optical signal in a first wavelength bandwidth into an optical signal in a second wavelength bandwidth different from the first wavelength bandwidth, and output the optical signal to an optical transmission line; and
an optical receiver configured to receive the optical signal in the second wavelength bandwidth from the optical transmission line, and cause the wavelength converter to convert the optical signal in the second wavelength bandwidth into the optical signal in the first wavelength bandwidth.

13. An optical waveguide substrate comprising:
a substrate; and
a plurality of optical waveguides formed of a semiconductor material having a nonlinear optical effect over the substrate,
wherein the plurality of optical waveguides are designed with design values different from each other, and an optical waveguide of the plurality of optical waveguides to be optically coupled to an optical fiber is selectable among the plurality of optical waveguides.

14. The optical waveguide substrate according to claim 13,
wherein widths, heights, or materials of the plurality of optical waveguides are different from each other.

15. The optical waveguide substrate according to claim 14,
wherein the width or the height of the optical waveguide is changed to a plus side and a minus side at predetermined spacings with a target design value as a center.

16. The optical waveguide substrate according to claim 13, further comprising:
a first optical switch provided with an incidence side of the plurality of optical waveguides; and
a second optical switch provided with an emission side of the plurality of optical waveguides,
wherein the first optical switch and the second optical switch are set such that an optical waveguide to be optically coupled to the optical fiber is selected among the plurality of optical waveguides.
